(19) United States
(12) Patent Application Publication
(10) Pub. No.: US 2025/0174222 A1
(43) Pub. Date: May 29, 2025

(54) DEVICE AND METHOD OF POST-HOC UTTERANCE REFINING BY ENTITY MINING FOR FAITHFUL KNOWLEDGE GROUNDED CONVERSATIONS

(71) Applicant: Korea University Research and Business Foundation, Seoul (KR)

(72) Inventors: Heuiseok LIM, Seoul (KR); Yoonna JANG, Seoul (KR)

(21) Appl. No.: 18/957,559

(22) Filed: Nov. 22, 2024

(30) Foreign Application Priority Data
Nov. 23, 2023 (KR) 10-2023-0164108

(51) Int. Cl. G10L 13/02; G06F 40/295

(52) U.S. Cl. CPC G10L 13/02; G06F 40/295

(57) ABSTRACT

Disclosed is a device and method for post-hoc utterance refining for faithful knowledge grounded conversation. The post-hoc utterance refining method is performed by a computing device including at least one processor, and includes generating, by a knowledge grounded conversation (KGC) model, utterance corresponding to knowledge and dialogue history; determining whether to refine the utterance based on source-faithfulness score indicating a degree to which the utterance reflects the knowledge; extracting a named entity from the knowledge; and regenerating the utterance based on the knowledge, the utterance, and the named entity.

### TECHNICAL FIELD

The present invention relates to a device and method for generating more faithful utterances through post-hoc refining to increase faithfulness of utterances when a machine provides knowledge grounded conversation to a person.

### BACKGROUND OF THE INVENTION

Knowledge grounded conversation (KGC), which is a subfield of a dialogue system, is a task of generating human-like utterances by referring to specialized knowledge such as Wikipedia. A knowledge grounded conversation (KGC) task requires the ability to generate fluent and informative utterances based on source knowledge.

A colossal number of training corpora and parameters have brought the recent explosive improvement in language generation performance in pre-trained language models (PLMs) and large language models (LLMs). However, hallucination, which has been a chronic issue in natural language generation, is still one of the biggest challenges remaining unsolved. In the knowledge grounded conversation (KGC) task, even though ground truth knowledge is given, the models make an error of generating hallucinated utterances not faithful to the source knowledge.

In particular, entity-level hallucination, generating names of entities (named entities) that are incorrect or not present in a source document, causes critical misinformation and jeopardizes the flow of conversation. As shown in Case 1 of FIG. 1, a previous KGC model may generate utterance containing information on a wrong entity, which is not given in knowledge. Also, as shown in Case 2, the generated utterance is excessively general while not considering sufficient entities that align with the context of conversation. These deficiencies may undermine the helpfulness of artificial intelligence (AI) conversational models. Although previous research has tried to mitigate them in general domain conversation, research to address the entity-level hallucination in KGC still remains in dark.

To address such entity-level hallucination problems, the present invention proposes a post-hoc utterance refining method by entity mining, called REM. Through this, more desirable and source-faithful KGC may be provided. REM may be used to refine unfaithful utterances generated by previous models in a plug-and-play manner. To refine utterances, an entity mining method is utilized. This method extracts named entities to implicitly utilize key information in knowledge in a multi-tasking manner. With this simple but effective method, REM aims to mitigate entity-level hallucination and to lead to a more successful conversation.

### DISCLOSURE

### Technical Problem

A technical subject to be achieved by the present invention is to provide a device and method for post-hoc utterance refining for faithful knowledge grounded conversation.

### Technical Solution

A post-hoc utterance refining method for faithful knowledge grounded conversation according to an example embodiment is performed by a computing device including at least one processor, and includes generating, by a knowledge grounded conversation (KGC) model, utterance corresponding to knowledge and dialogue history; determining whether to refine the utterance based on source-faithfulness score indicating a degree to which the utterance reflects the knowledge; extracting a named entity from the knowledge; and regenerating the utterance based on the knowledge, the utterance, and the named entity.

### Advantages Effects

According to a device and method for post-hoc utterance refining for faithful knowledge grounded conversation according to an example embodiment, it is possible to detect the hallucination effect occurring in a knowledge grounded conversation (KGC) system and to mitigate the same through regeneration. In particular, more accurate utterance regeneration is possible by focusing on named entities in a knowledge document.

### DESCRIPTION OF DRAWINGS

Detailed description related to each drawing is provided to further sufficiently understand drawings cited in the detailed description of the present invention.

FIG. 1 illustrates an example of utterances with entity-level hallucination and desirable utterances in knowledge grounded conversation;

FIG. 2 illustrates a graphical model of (a) knowledge grounded conversation (KGC) and a graphical model of (b) REM proposed in the present invention;

FIG. 3 illustrates the entire architecture of a REM model that includes an entity miner and an utterance generator; and

FIG. 4 is a flowchart illustrating a post-hoc utterance refining method for faithful knowledge grounded conversation according to an example embodiment.

### DETAILED DESCRIPTION OF THE INVENTION

Disclosed hereinafter are exemplary embodiments of the present invention. Particular structural or functional descriptions provided for the embodiments hereafter are intended merely to describe embodiments according to the concept of the present invention. The embodiments are not limited as to a particular embodiment.

Various modifications and/or alterations may be made to the disclosure and the disclosure may include various example embodiments. Therefore, some example embodiments are illustrated as examples in the drawings and described in detailed description. However, they are merely intended for the purpose of describing the example embodiments described herein and may be implemented in various forms. Therefore, the example embodiments are not construed as limited to the disclosure and should be understood to include all changes, equivalents, and replacements within the idea and the technical scope of the disclosure.

Terms such as “first” and “second” may be used to describe various parts or elements, but the parts or elements should not be limited by the terms. The terms may be used to distinguish one element from another element. For instance, a first element may be designated as a second element, and vice versa, while not departing from the extent of rights according to the concepts of the present invention.

Unless otherwise clearly stated, when one element is described, for example, as being “connected” or “coupled” to another element, the elements should be construed as being directly or indirectly linked (i.e., there may be an intermediate element between the elements). Similar interpretation should apply to such relational terms as “between”, “neighboring,” and “adjacent to.”

Terms used herein are used to describe a particular exemplary embodiment and should not be intended to limit the present invention. Unless otherwise clearly stated, a singular term denotes and includes a plurality. Terms such as “including” and “having” also should not limit the present invention to the features, numbers, steps, operations, subparts and elements, and combinations thereof, as described; others may exist, be added or modified. Existence and addition as to one or more of features, numbers, steps, etc. should not be precluded.

Unless otherwise clearly stated, all of the terms used herein, including scientific or technical terms, have meanings which are ordinarily understood by a person skilled in the art. Terms, which are found and defined in an ordinary dictionary, should be interpreted in accordance with their usage in the art. Unless otherwise clearly defined herein, the terms are not interpreted in an ideal or overly formal manner.

Hereinafter, example embodiments will be described with reference to the accompanying drawings. However, the scope of the patent application is not limited to or restricted by such example embodiments. Like reference numerals used herein refer to like elements throughout.

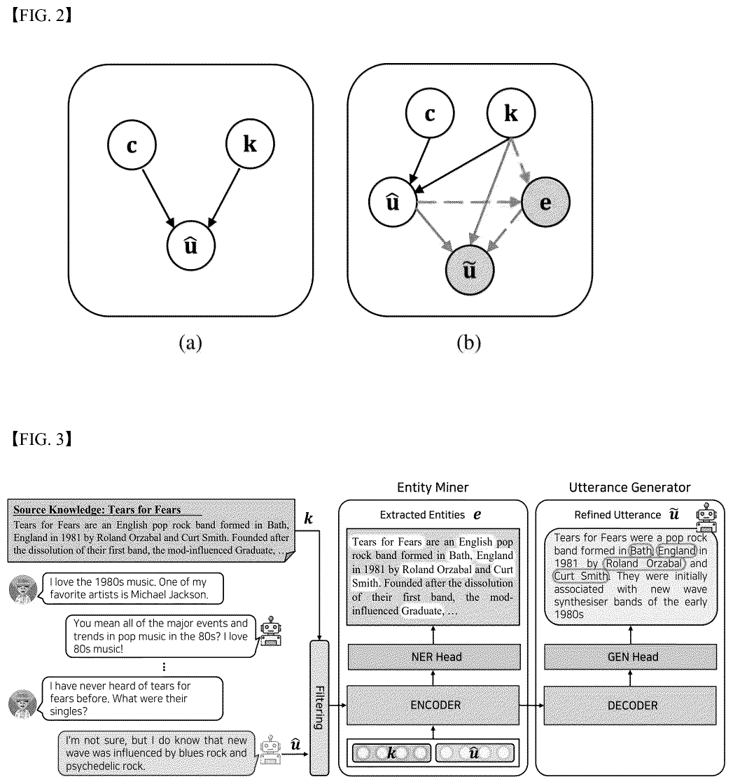

A post-hoc utterance refining method (REM) proposed in the present invention aims to refine utterance generated by a model (, which may represent arbitrary or existing knowledge grounded conversation (KGC) model,) to be more faithful to source knowledge as shown in FIG. 3. The utterance is filtered by a faithfulness scoring function and whether to be refined is determined. To this end, a pre-trained language model with an encoder-decoder structure may be trained. In a REM model, an entity miner extracts a named entity from source knowledge and utilizes the named entity to implicitly learn key information of the named entity. Through this, an utterance generator may generate more faithful utterances.

### Knowledge Grounded Conversation

FIG. 2 illustrates a graphical model of (a) knowledge grounded conversation (KGC) and a graphical model of (b) REM proposed in the present invention. The black line may be modeled by KGC model parameter θ. The yellow and blue lines represent an entity miner that is implicitly modeled and an utterance generator, respectively. The colored lines, that is, the yellow and blue lines, may be modeled by REM parameter ψ.

As shown in (a) of FIG. 2, the knowledge grounded conversation (KGC) model generates the informative utterance û considering both conversational context c and corresponding source knowledge k as shown in Equation 1. That is, the knowledge grounded conversation (KGC) model may receive the source knowledge k and the conversational context (, which may indicate dialogue history), and may generate utterance as a response to a user query and then may provide the same to a user.

$${p}_{θ} ( \hat{u} \vert k , c ) = {\prod }_{t = 1}^{n} {p}_{θ} ( {\hat{u}}_{t} \vert {\hat{u}}_{< t} , k , c ) \qquad [ Equation 1 ]$$

In Equation 1, n denotes a maximum sequence length of the utterance and θ denotes the parameter of the knowledge grounded conversation (KGC) model.

### Post-Hoc Utterance Refining

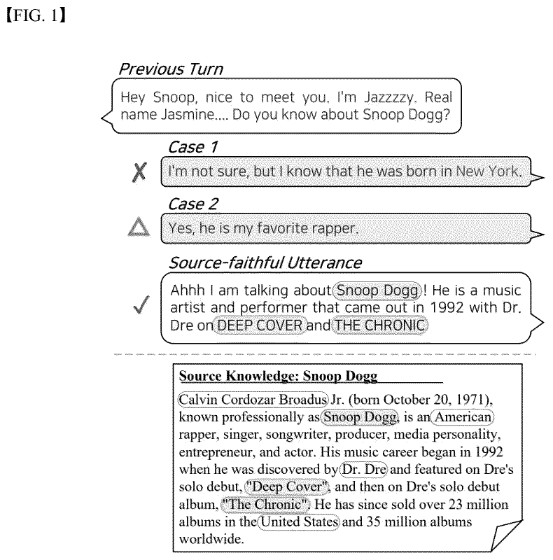

While the knowledge grounded conversation (KGC) model aims to generate informative utterances (or knowledgeable utterances), the utterance û generated by the knowledge grounded conversation (KGC) model may not faithfully reflect input source knowledge as shown in FIG. 1. In this context, the present invention first filters out the utterance that is not faithful to the source. Then, as in Equation 2, the given utterance is renovated into the refined utterance ū that represents the intended knowledge better by using the model-generated utterance û and its corresponding knowledge k.

$${p}_{ψ} ( \tilde{u} \vert k , \hat{u} ) = {\prod }_{t = 1}^{n} {p}_{ψ} ( {\tilde{u}}_{t} \vert {\tilde{u}}_{< t} , k , \hat{u} ) \qquad [ Equation 2 ]$$

In Equation 2, ψ denotes the parameter of the REM model.

Faithfulness Filtering: To filter the model-generated utterance û, the source-faithfulness score is quantified. The source-faithfulness score represents how the utterance û is consistent with the source knowledge k. To this end, the present invention adopts the Dependency Arc Entailment (DAE) (Tanya Goyal and Greg Durrett. 2020. Evaluating factuality in generation with dependency-level entailment. arXiv preprint arXiv:2010.05478.) as a scoring function to estimate entailment between the source knowledge and û in consideration of dependency arc-level consistency of the utterance.

Only utterances that have lower scores than a threshold may be refined according to the source-faithfulness score, as shown in Equation 3.

$$\tilde{u} = \{ \begin{matrix}REM ( k , \hat{u} ) & : if score ( k , \hat{u} ) < τ \\ \hat{u} & : otherwise\end{matrix} \qquad [ Equation 3 ]$$

In Equation 3, score(.) denotes the scoring function (i.e., DAE) and t denotes a threshold score (value between 0 and 1). When t is 0, all utterances are regenerated as ũ. When τ is 1, all utterances are not refined. In the present invention, this filtering module is utilized only in the inference stage, not in a training stage.

Refining Utterance by Entity Mining (REM): The refining method (REM) proposed herein may include two sub-modules, that is, (1) the entity miner and (2) the utterance generator as shown in FIG. 3. The refining task may be formulated as shown in Equation 4.

$${p}_{ψ} ( \tilde{u} \vert k , \hat{u} ) ∝ {\underbrace{{p}_{ψ} ( e \vert k , \hat{u} )}}_{Entity miner} {\underbrace{{p}_{ψ} ( \tilde{u} \vert e , k , \hat{u} )}}_{Utterance generator} \qquad [ Equation 4 ]$$

These two modules may be trained in a multi-tasking manner with the parameter ψ. The entity miner mines entities e from the source knowledge and implicitly learns entity-level knowledge. The utterance generator learns a method of generating the utterance ũ using the implicitly mined entities. The extracted entity is key information of the source knowledge, reducing entity-level hallucination and generating more source-faithful utterances.

Training Objectives: The training objective of REM is divided into named entity recognition (NER) by the entity miner and utterance regeneration (GEN) by the utterance generator.

To predict the named entities, the NER head is attached on top of the encoder and extracts entities inside knowledge k. It makes the model learn essential entity information, enhancing interpretation of the source knowledge. To train NER, named entities may be tagged with one of entity types {′LOC′, ‘PER’, ‘ORG’, ‘MISC’} using an available entity-tagging module (e.g., https://github.com/flairNLP/flair). NER loss L_{NER} is only defined for NER label lᵢ tagged for each token kᵢ in k and minimized during training as shown in Equation 5.

$${ℒ}_{NER} = - \frac{1}{{N}_{k}} {{\sum }_{i = 1}}^{{N}_{k}} {l}_{i} log p ( {k}_{i} \vert \hat{u} ) \qquad [ Equation 5 ]$$

In Equation 5, Nₖ denotes a token length of source knowledge.

The language modeling head (GEN) learns to refine the given-model-generated utterance û with k in an auto-regressive manner while extracting entities e. The model learns to compose information of inputs and extracted entities from an encoder hidden state. This model is trained by minimizing the loss function shown in Equation 6.

$${ℒ}_{GEN} = - \frac{1}{{N}_{u}} {{\sum }_{i = 1}}^{{N}_{u}} log p ( {u}_{i} \vert {u}_{< i} , k , \hat{u} ; e ) \qquad [ Equation 6 ]$$

In Equation 6, e is implicitly extracted in the encoder during training.

The final training objective of REM trained on both tasks is as shown in Equation 7. In Equation 7, An denotes a training hyperparameter and may be understood as a weight.

$${ℒ}_{REM} = {λ}_{1} {ℒ}_{NER} + {λ}_{2} {ℒ}_{GEN} \qquad [ Equation 7 ]$$

### Experimental Results

In the following, datasets, automatic evaluation metric, and a baseline model are described.

### Datasets

In experiments, three datasets are utilized.

FoCus (Yoonna Jang, Jungwoo Lim, Yuna Hur, Dongsuk Oh, Suhyune Son, Yeonsoo Lee, Donghoon Shin, Seungryong Kim, and Heuiseok Lim. 2022. Call for customized conversation: Customized conversation grounding persona and knowledge. In Proceedings of the AAAI Conference on Artificial Intelligence, volume 36, pages 10803-10812.), which considers both knowledge and persona in conversation, has been released. In FoCus, machine generates utterances with customized and knowledge-able utterances about world landmarks. Wizard of Wikipedia (WoW) (Emily Dinan, Stephen Roller, Kurt Shuster, Angela Fan, Michael Auli, and Jason Weston. 2018. Wizard of wikipedia: Knowledge-powered conversational agents. arXiv preprint arXiv: 1811.01241.), which is a widely used benchmark, includes Wizard and Apprentice that talk to each other on various topics of Wikipedia. Another dataset, CMUDoG (Kangyan Zhou, Shrimai Prabhumoye, and Alan W Black. 2018. A dataset for document grounded conversations. In Proceedings of the 2018 Conference on Empirical Methods in Natural Language Processing, pages 708-713.) includes conversation between two speakers discussing different aspects of a specific movie, such as information and plot.

### Automated Evaluation Metrics

The present invention evaluates the refining performance of REM with automated metrics in three criteria, source-faithfulness, reference matching, and diversity. To evaluate source-faithfulness, DAE, entity coverage (EC), and entity type coverage (TC) are utilized. DAE (Tanya Goyal and Greg Durrett. 2020. Evaluating factuality in generation with dependency-level entailment. arXiv preprint arXiv:2010.05478.) is used to assess whether the system accurately reflects the facts from the given knowledge when generating utterance at the level of dependency arcs. Also, two entity-level metrics (EC and TC) may be further utilized to evaluate source-faithfulness in terms of the entity. For the reference matching n-gram score, chrF (Maja Popovic. 2015. chrf: character n-gram f-score for automatic mt evaluation. In Proceedings of the tenth workshop on statistical machine translation, pages 392-395.), ROUGE-L (Chin-Yew Lin. 2004. Rouge: A package for automatic evaluation of summaries. In Text summarization branches out, pages 74-81.), and SacreBLEU (Matt Post. 2018. A call for clarity in reporting bleu scores. arXiv preprint arXiv:1804.08771.) are utilized to evaluate how close the generated hypothesis is to the ground-truth answer in the test set. For diversity evaluation, Distinct-N (github.com/neural-dialogue-metrics/distinct-N, Jiwei Li, Michel Galley, Chris Brockett, Jianfeng Gao, and Bill Dolan. 2015. A diversity-promoting objective function for neural conversation models. arXiv preprint arXiv:1510.03055.) is adopted.

Entity Coverage and Entity Type Coverage: Entity coverage (CT) and entity type coverage (TC) are computed to quantify the extent of correct entities and context coherence, respectively. To compute EC and TC, named entities may be extracted from the generated utterance up (including ũ and Û.), source knowledge k, and ground truth (GT) utterance u, using an arbitrary NER model. First, a ratio of named entities included in the generated utterance up is evaluated through comparison with the GT utterance u, as shown in Equation 8.

$$EC = \frac{𝒩 ( ( {E}_{k} ⋂ {E}_{u} ) ⋂ {E}_{{u}_{p}} )}{𝒩 ( {E}_{k} ⋂ {E}_{u} )} \qquad [ Equation 8 ]$$

In Equation 8, N(l) denotes the number of values within list l, and Eₖ denotes a set of named entities in source knowledge. Eᵤ and Eᵤₚ denote the set of named entities in the GT utterance and the generated utterance, respectively.

Also, TC is evaluated for comparison with the existing model that produces fluent text but demonstrates low context coherence. To identify the intent of context and information that needs to be included in a response, the named entity type within the GU utterance u is utilized. For example, if the entity type ‘LOC’ has the highest proportion among named entities in u, it indicates that the conversation is focused on location-related information. In this case, the model needs to generate a response that is relevant to a location to ensure coherence and relevance in the conversation.

From this perspective, for each named entity type, the ratio of entity types extracted from the generated utterance up is computed compared to the GT utterance u as shown in Equation 9.

$$TC = \frac{1}{\vert T \vert} {{\sum }_{t}}^{T} ( \frac{𝒩 ( {E}_{{u}_{p}}^{t} )}{𝒩 ( {E}_{u}^{t} )} ) \qquad [ Equation 9 ]$$

In Equation 9, T denotes a set of named entity types {‘LOC’, ‘PER’, ‘ORG’, ‘MISC’} O|⊏|.

### KGC Baselines

BART: BART (Mike Lewis, Yinhan Liu, Naman Goyal, Marjan Ghazvininejad, Abdelrahman Mohamed, Omer Levy, Veselin Stoyanov, and Luke Zettlemoyer. 2020a. Bart: Denoising sequence-to-sequence pre-training for natural language generation, translation, and comprehension. In Proceedings of the 58th Annual Meeting of the Association for Computational Linguistics, pages 7871-7880.) is a transformer-based pre-trained model with encoder-decoder structure. BART utilizes various noising methods and in-filling schemes during pre-training. The present invention fine-tunes BART on three KGC datasets.

INFO: INFO (Jungwoo Lim, Myugnhoon Kang, Yuna Hur, Seung Won Jeong, Jinsung Kim, Yoonna Jang, Dongyub Lee, Hyesung Ji, DongHoon Shin, Seungryong Kim, et al. 2022. You truly understand what I need: Intellectual and friendly dialog agents grounding persona and knowledge. In Findings of the Association for Computational Linguistics: EMNLP 2022, pages 1053-1066.) uses RAG to enhance factuality of generation results in FoCus dataset. It retrieves a large number of knowledge documents and generates informative conversation based on them.

EDMem: The present invention utilizes and refines utterances generated by EDMem (Zhihan Zhang, Wenhao Yu, Chenguang Zhu, and Meng Jiang. 2022. A unified encoder-decoder framework with entity memory. arXiv preprint arXiv:2210.03273.). EDMem is pre-trained on Wikipedia documents to learn entity embeddings and incorporates entity knowledge for entity-intensive dialogue generation.

ITDD: ITDD (Zekang Li, Cheng Niu, Fandong Meng, Yang Feng, Qian Li, and Jie Zhou. 2019. Incremental transformer with deliberation decoder for document grounded conversations. arXiv preprint arXiv:1907.08854.) is the best-performing method on the CMUDoG dataset. With a two-pass decoder inspired by a human cognitive process, context coherence and knowledge correctness are improved.

### Experimental Results and Analysis

### Post-Hoc Refining Ability

To demonstrate post-hoc refining ability, the refining performance of REM with vanilla PLM fine-tuned on three datasets and existing models is evaluated. The results are shown in Table 1. REM_{base} and REM_{large} refer to models trained using the REM method on BART-base and BART-large.

TABLE 1

| | | Source-faithfulness | | | Reference Matching | | | Diversity | |
|---|---|---|---|---|---|---|---|---|---|
| Data | Model | EC (%) | TC (%) | DAE | chrF | ROUGE-L | BLEU | Dist-1 | Dist-2 |
| FoCus | BART_{base} | 7.54 | 13.85 | 0.60 | 19.47 | 28.04 | 2.51 | 0.37 | 0.80 |
| | +REM_{base} (Ours) | 23.40 | 20.32 | 0.83 | 30.38 | 33.14 | 9.47 | 0.28 | 0.73 |
| WoW | BART_{base} | 14.23 | 8.80 | 0.84 | 31.70 | 34.02 | 12.72 | 0.31 | 0.78 |
| | +REM_{base} (Ours) | 14.57 | 9.03 | 0.87 | 32.44 | 34.17 | 12.83 | 0.29 | 0.77 |
| CMUDoG | BART_{base} | 3.40 | 3.90 | 0.26 | 12.92 | 13.14 | 3.25 | 0.40 | 0.83 |
| | +REM_{base} (Ours) | 4.95 | 7.55 | 0.40 | 15.06 | 11.92 | 2.49 | 0.25 | 0.70 |
| FoCus^{†} | INFO | 0.05 | 24.40 | 0.79 | 50.35 | 54.27 | 32.55 | 0.26 | 0.70 |
| | +REM_{large} (Ours) | 0.11 | 25.48 | 0.86 | 49.98 | 52.30 | 30.17 | 0.24 | 0.68 |
| WoW^{†} | EDMem | 0.00 | 3.50 | 0.50 | 14.30 | 15.21 | 2.90 | 0.28 | 0.71 |
| | +REM_{large} (Ours) | 4.51 | 6.51 | 0.77 | 19.46 | 18.30 | 4.25 | 0.25 | 0.68 |
| CMUDoG^{†} | ITDD | 0.00 | 1.42 | 0.12 | 9.30 | 9.39 | 1.71 | 0.48 | 0.82 |
| | +REM_{large} (Ours) | 1.01 | 3.96 | 0.30 | 13.64 | 10.44 | 1.74 | 0.24 | 0.67 |

Fine-tuned Baselines: The comparison results of REM with the vanilla PLM fine-tuned on three datasets are presented at the top of Table 1. The BART-base model is fine-tuned with each dataset and it is referred to as BART_{base}. To the generated output of BART_{base}, the refining performance with REM_{base} is evaluated. The experimental results demonstrate that the REM leads to improvements not only in scores of source-faithfulness metrics but also in reference matching metrics.

In contrast, REM shows a tendency to decrease the performance of diversity metrics. This indicates that, in BART_{base}-generated utterances, there are tokens that contribute to increased diversity but also lead to hallucination. These hallucinated tokens are subsequently refined through the REM process. In particular, the significant improvement in EC and TC metrics suggest that entities that cause entity-level hallucination are refined during the refining process with REM.

### Existing Baselines

To investigate adaptability of REM, the refining performance is compared with previous studies and the results are annotated with † symbol in Table 1. EDMem, ITDD, and INFO are re-implemented for fair comparison with REM_{large}. The experimental results show that REM_{large} exhibits improvement in source-faithfulness performance. Also, it demonstrates enhanced generation performance in the reference matching score, excluding INFO. The reason is that INFO utilizes a large number of knowledge documents for generation, whereas REM generates utterances based on given GT knowledge within the dataset. Also, while the source-faithfulness score increases, the diversity score decreases. This result discusses that REM removes tokens that enhance diversity but also contribute to entity hallucination. This is similar to the results observed with Vanilla PLM.

### Cross-Data Utterance Refining

To inspect flexibility of REM, cross-data experiments are conducted and the results are shown in Table 2.

TABLE 2

| | | Source-faithfulness | | | Ref. Matching | |
|---|---|---|---|---|---|---|
| Train | Test | EC (%) | TC (%) | DAE | chrF | R-L |
| FoCus | FoCus | 50.64 | 29.88 | 0.84 | 50.47 | 46.55 |
| WoW | | 0.03 | 8.35 | 0.03 | 9.24 | 8.65 |
| CMUDoG | | 17.02 | 16.20 | 0.29 | 21.32 | 15.72 |
| WoW | WoW | 20.84 | 13.59 | 0.77 | 37.18 | 31.55 |
| FoCus | | 21.21 | 14.51 | 0.78 | 36.76 | 30.12 |
| CMUDoG | | 18.99 | 12.73 | 0.74 | 35.23 | 29.16 |
| CMUDoG | CMUDoG | 6.90 | 9.50 | 0.43 | 16.42 | 12.44 |
| FoCus | | 12.51 | 29.17 | 0.83 | 13.37 | 7.08 |
| WoW | | 3.40 | 3.90 | 0.26 | 12.92 | 13.14 |

Table 2 shows the results of cross-data experiments with REM_{large}. Here, τ=1.0. That is, refining for all utterances is performed.

REM trained on CMUDoG consistently underperforms in source-faithfulness and reference matching scores. When refining FoCus test set with REM trained on CMUDOG, the performance significantly decreases in all metrics. This tendency is similarly shown in the results of WoW test set. Likewise, REM trained on WOW exhibits a decrease in performance on Focus and CMUDoG test sets.

According to Dziri et at. (Nouha Dziri, Sivan Milton, Mo Yu, Osmar Zaiane, and Siva Reddy. 2022b. On the origin of hallucinations in conversational models: Is it the datasets or the models? arXiv preprint arXiv:2204.07931.) that analyzes the portion of hallucination in KGC dataset, the reason for the performance decrease is hallucinated utterances in WOW and DMUDOG dataset. The results show that only 24.15% of utterances in WoW and 16.2% of utterances in CMUDoG exhibit entailment. These proportions indicate that a significant portion of utterances contains knowledge hallucination. Therefore, hallucination in the dataset has an impact on model training and evaluation.

On the other hand, FoCus dataset demonstrates high source-faithfulness performance across all datasets. It is assumed that the reason for performance difference lies in dataset construction. While WOW and CMUDoG provide response without knowledge, FoCus generates utterances based on knowledge. Therefore, REM trained on Focus facilitates training of a more faithful KGC model.

### Adversarial Data Refining

To investigate validity of REM, ChatGPT was prompted to generate synthetic data by changing the GT utterance in an adversarial manner. The performance of REM is to be demonstrated by refining utterances that are distorted to be unfaithful to source knowledge. Here, all data is refined with (i.e., τ=1.0). As presented in Table 3, compared to the adversarially synthesized data (ADV), both source-faithfulness and reference matching scores significantly increase after refining. ROUGE-L score of ADV is slightly higher in CMUDoG, which is likely due to the characteristic that utterances of CMUDoG have much shorter lengths than other datasets.

TABLE 3

| | | Source-faithfulness | | | Ref. Matching | |
|---|---|---|---|---|---|---|
| Data | Model | EC (%) | TC (%) | DAE | chrF | R-L |
| FoCus | ADV | 27.77 | 19.28 | 0.63 | 27.09 | 31.10 |
| | +REM_{base} | 46.68 | 35.41 | 0.85 | 42.49 | 37.00 |
| | +REM_{large} | 48.04 | 34.19 | 0.87 | 41.91 | 36.87 |
| WoW | ADV | 5.94 | 5.82 | 0.32 | 16.53 | 16.78 |
| | +REM_{base} | 18.93 | 12.71 | 0.75 | 33.03 | 29.33 |
| | +REM_{large} | 17.58 | 12.38 | 0.75 | 34.09 | 28.74 |
| CMUDoG | ADV | 3.33 | 4.98 | 0.23 | 12.07 | 12.04 |
| | +REM_{base} | 5.21 | 10.08 | 0.44 | 15.37 | 10.92 |
| | +REM_{large} | 5.99 | 9.24 | 0.42 | 15.55 | 11.43 |

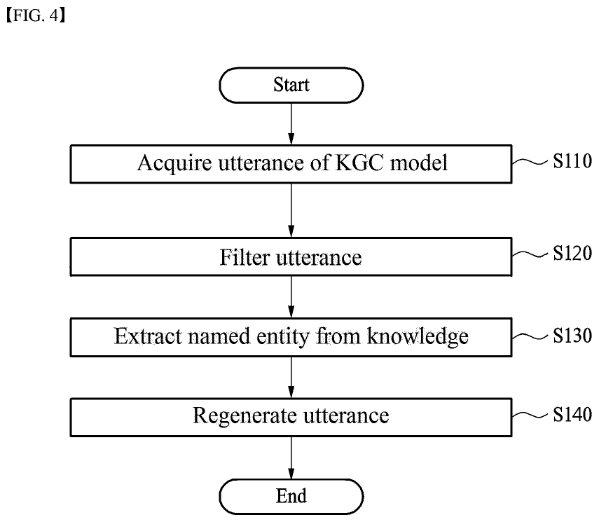

FIG. 4 is a flowchart illustrating a post-hoc utterance refining method according to an example embodiment.

Referring to FIG. 4, the post-hoc utterance refining method may be performed by a computing device at least including a processor and/or a memory. That is, at least a portion of operations included in the post-hoc utterance refining method may be performed as an operation of the processor that is included in the computing device. The computing device may also be referred to as a post-hoc utterance refining device. The computing device may include, for example, a personal computer (PC), a server, a laptop computer, a tablet PC, and a smartphone. Also, the computing device may be implemented as physically separated devices. Hereinafter, in describing the post-hoc utterance refining method, specific description related to content overlapping with the previous description is omitted.

Initially, in operation S110, a response of a knowledge grounded conversation (KGC) model corresponding to given knowledge k and context c is acquired. The knowledge grounded conversation model may refer to an arbitrary natural language generation model or a large language model. Here, the response may be derived using a knowledge grounded conversation model stored in the computing device.

In operation S120, filtering is performed on the response of the knowledge grounded conversation (KGC) model. In detail, whether the generated utterance faithfully reflects source knowledge may be determined. That is, the source-faithfulness score may be computed and whether refining for the utterance is performed may be determined based on the source-faithfulness score. Here, the source-faithfulness score may be computed through an arbitrary scoring function (e.g., DAE). When the computed source-faithfulness score is lower than a predetermined threshold, the utterance is subject to refining.

In operation S130, a named entity is extracted from source knowledge. The named entity may be extracted through a named entity recognition (NER) scheme.

In operation S140, the utterance may be regenerated based on the extracted named entity. Regeneration of the utterance may be performed through an utterance regeneration model generated through training of a natural language processing model with an encoder-decoder structure. That is, the utterance regeneration model may refer to a model that is trained to receive at least one of output (i.e., generated utterance), knowledge k, and the extracted named entity of the knowledge grounded conversation (KGC) model and to regenerate the utterance.

The device described above can be implemented as hardware elements, software elements, and/or a combination of hardware elements and software elements. For example, the device and elements described with reference to the embodiments above can be implemented by using one or more general-purpose computer or designated computer, examples of which include a processor, a controller, an ALU (arithmetic logic unit), a digital signal processor, a microcomputer, an FPGA (field programmable gate array), a PLU (programmable logic unit), a microprocessor, and any other device capable of executing and responding to instructions. A processing device can be used to execute an operating system (OS) and one or more software applications that operate on the said operating system. Also, the processing device can access, store, manipulate, process, and generate data in response to the execution of software. Although there are instances in which the description refers to a single processing device for the sake of easier understanding, it should be obvious to the person having ordinary skill in the relevant field of art that the processing device can include a multiple number of processing elements and/or multiple types of processing elements. In certain examples, a processing device can include a multiple number of processors or a single processor and a controller. Other processing configurations are also possible, such as parallel processors and the like.

The software can include a computer program, code, instructions, or a combination of one or more of the above and can configure a processing device or instruct a processing device in an independent or collective manner. The software and/or data can be tangibly embodied permanently or temporarily as a certain type of machine, component, physical equipment, virtual equipment, computer storage medium or device, or a transmitted signal wave, to be interpreted by a processing device or to provide instructions or data to a processing device. The software can be distributed over a computer system that is connected via a network, to be stored or executed in a distributed manner. The software and data can be stored in one or more computer-readable recorded medium.

A method according to an embodiment of the invention can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc., specially designed to store and execute program instructions. Examples of the program instructions may include not only machine language codes produced by a compiler but also high-level language codes that can be executed by a computer through the use of an interpreter, etc. The hardware mentioned above can be made to operate as one or more software modules that perform the actions of the embodiments of the invention and vice versa.

Although the present invention is described with reference to the example embodiments illustrated in the drawings, it is provided as an example only and it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents. Therefore, other implementations, other example embodiments, and equivalents are within the scope of the following claims.

What is claimed is:

1. A post-hoc utterance refining method, performed by a computing device comprising at least one processor, the method comprising:
generating, by a knowledge grounded conversation (KGC) model, utterance corresponding to knowledge and dialogue history;
determining whether to refine the utterance based on source-faithfulness score indicating a degree to which the utterance reflects the knowledge;
extracting a named entity from the knowledge; and
regenerating the utterance based on the knowledge, the utterance, and the named entity.

2. The method of claim 1, wherein the source-faithfulness score is computed by utilizing Dependency Arc Entailment (DAE) as a scoring function.

3. The method of claim 2, wherein the determining whether to refine the utterance comprises determining to refine the utterance when the source-faithfulness score is lower than a threshold.

4. The method of claim 3, wherein the regenerating comprises regenerating the utterance using an utterance regeneration model that is trained to receive at least one of the knowledge, the utterance, and the entity name included in the knowledge and to output the refined utterance.
